(19) United States
(12) Patent Application Publication
(10) Pub. No.: US 2020/0108914 A1
(43) Pub. Date: Apr. 9, 2020

(54) UNMANNED AERIAL VEHICLE AND METHOD FOR CONTROLLING SAME

(71) Applicant: Samsung Electronics Co., Ltd, Suwon-si (KR)

(72) Inventors: Eun Kyung YOO, Seoul (KR); Choon Kyoung MOON, Suwon-si (KR)

(21) Appl. No.: 16/499,854

(22) PCT Filed: Mar. 22, 2018
(86) PCT No.: PCT/KR2018/003375

§ 371 Date: Sep. 30, 2019

(30) Foreign Application Priority Data
Mar. 31, 2017 (KR) 10-2017-0041460

(51) Int. Cl. B64C 13/16; B64C 39/02; B64D 47/08; G05D 1/00; G05D 1/08

(52) U.S. Cl. CPC B64C 13/16; B64C 39/024; B64D 47/08; B64C 2201/141; G05D 1/0808; B64C 2201/108; B64C 2201/127; G05D 1/0033

(57) ABSTRACT

An UAV according to an embodiment may include housing, a tactile sensor disposed on at least a partial surface of the housing, at least one motor, a propeller connected the at least one motor, and a processor electrically connected to the tactile sensor and the at least one motor and controlling the at least one motor. Moreover, various embodiment grasped through the disclosure are possible.

### CROSS-REFERENCE TO RELATED APPLICATIONS

This application is a 371 of International Application No. PCT/KR2018/003375 filed on Mar. 22, 2018, which claims priority to Korean Patent Application No. 10-2017-0041460 filed on Mar. 31, 2017, the disclosures of which are herein incorporated by reference in their entirety.

### BACKGROUND

### 1. Field

The disclosure relates to an unmanned aerial vehicle (UAV) and a method for controlling the UAV.

### 2. Description of Related Art

A UAV may fly in three-dimensional space by having its own lift source. The UAV referred to as a drone, an unmanned aircraft system (UAS), or the like may fly through remote control even though humans do not directly ride on the UAV.

In recent years, the low-priced UAV has been widely distributed to people with the development of technologies, and the UAV has been used in various fields such as military, agriculture, logistics, leisure, and the like. For example, the UAV may perform functions such as aerial photography, logistics delivery, or spraying pesticide.

The UAV may be remotely controlled through an electronic device such as a dedicated controller, a smartphone, or the like. For example, a user may control not only the location, altitude, or the like of the UAV using the dedicated controller, the smart phone, or the like, but also various modules (e.g., a camera, a pesticide sprayer, or the like) included in the payload of the UAV.

The skilled techniques are required to utilize such the above-described UAV. Accordingly, it is not easy for a user, which lacks experience, to control the UAV.

Various embodiments of the disclosure may provide a method of moving a UAV, which is hovering, to a location desired by a user without using a separate controller, and the UAV to which the method is applied.

### SUMMARY

According to an embodiment disclosed in the disclosure, a UAV may include housing, a tactile sensor disposed on at least a partial surface of the housing, at least one motor, a propeller connected the at least one motor, and a processor electrically connected to the tactile sensor and the at least one motor and controlling the at least one motor. The tactile sensor may include a first tactile sensor disposed on an upper surface of the housing, a second tactile sensor disposed on a lower surface of the housing, and a third tactile sensor disposed on a side surface of the housing. The processor may be configured to control the at least one motor such that the UAV performs a hovering operation at a first location, to release limitation of vertical movement when a touch is sensed by the first tactile sensor or the second tactile sensor, and release limitation of horizontal movement when a touch is detected by the third tactile sensor, to determine a second location different from the first location, based on the sensed touch, and to control the at least one motor such that the UAV performs a hovering operation at the second location.

According to an embodiment disclosed in the disclosure, a UAV may include housing, a tactile sensor disposed on at least a partial surface of the housing, an accelerometer disposed inside the housing, at least one motor, a propeller connected the at least one motor, and a processor electrically connected to the tactile sensor and the at least one motor and controlling the at least one motor. The processor may be configured to control the at least one motor such that the UAV performs a hovering operation at a first location, to release limitation of vertical movement and horizontal movement when a specified touch is sensed by the tactile sensor, to reduce an output of the at least one motor to a specified output value or less, and to increase the output of the at least one motor to the specified output value or more to perform a hovering operation at a second location when an acceleration value detected by the accelerometer is reduced to a specified value or less. The second location may correspond to a location of the UAV at a point in time when an acceleration value is reduced to a specified value or less.

According to embodiments disclosed in the disclosure, even non-skilled persons may intuitively change the location of the UAV, without a separate controller. In this way, when an image or video is captured using the camera attached to the UAV, it is possible to easily obtain the view desired by a user. Besides, a variety of effects directly or indirectly understood through the disclosure may be provided.

### BRIEF DESCRIPTION OF THE DRAWINGS

FIG. 1 illustrates a perspective view and an exploded perspective view of a UAV, according to an embodiment.

FIGS. 2A to 2C illustrate a top view, a bottom view, and a side view of a UAV, according to various embodiments.

FIG. 3 illustrates a configuration of a UAV, according to an aspect.

FIG. 4 illustrates a configuration of a UAV, according to another aspect.

FIG. 5 illustrates a state diagram of a UAV, according to an embodiment.

FIGS. 6A and 6B are views for describing a flight controlling method, according to an embodiment.

FIG. 7 is a flowchart illustrating a flight controlling method, according to an embodiment.

FIGS. 8A and 8B are flowcharts illustrating obstacle collision avoidance, according to an embodiment.

FIG. 9 is a view for describing a flight controlling method, according to another embodiment.

FIG. 10 is a flowchart illustrating a flight controlling method, according to another embodiment.

FIG. 11 is a graph illustrating a speed of a propeller in flight control, according to an embodiment; and

FIGS. 12 and 13 are views for describing camera control in flight control, according to an embodiment.

With regard to description of drawings, similar components may be marked by similar reference numerals.

### DETAILED DESCRIPTION

Hereinafter, various embodiments of the disclosure will be described with reference to accompanying drawings. However, it should be understood that the disclosure is not intended to be limited to a specific embodiment, but intended to include various modifications, equivalents, and/or alternatives of the corresponding embodiment.

Various embodiments of the disclosure and terms used herein are not intended to limit the technologies described in the disclosure to specific embodiments, and it should be understood that the embodiments and the terms include modification, equivalent, and/or alternative on the corresponding embodiments described herein. With regard to description of drawings, similar components may be marked by similar reference numerals. The terms of a singular form may include plural forms unless otherwise specified. In the disclosure disclosed herein, the expressions “A or B”, “at least one of A and/or B”, “A, B, or C”, or “at least one of A, B, and/or C”, and the like used herein may include any and all combinations of one or more of the associated listed items. Expressions such as “first,” or “second,” and the like, may express their components regardless of their priority or importance and may be used to distinguish one component from another component but is not limited to these components. When a (e.g., first) component is referred to as being “(operatively or communicatively) coupled with/to” or “connected to” another (e.g., second) component, it may be directly coupled with/to or connected to the other component or an intervening component (e.g., a third component) may be present.

According to the situation, the expression “adapted to or configured to” used herein may be interchangeably used as, for example, the expression “suitable for”, “having the capacity to”, “changed to”, “made to”, “capable of” or “designed to”. The expression “a device configured to” may mean that the device is “capable of” operating together with another device or other parts. For example, a “processor configured to (or set to) perform A, B, and C” may mean a dedicated processor (e.g., an embedded processor) for performing corresponding operations or a generic-purpose processor (e.g., a central processing unit (CPU) or an application processor) which performs corresponding operations by executing one or more software programs which are stored in a memory device (e.g., the memory 30).

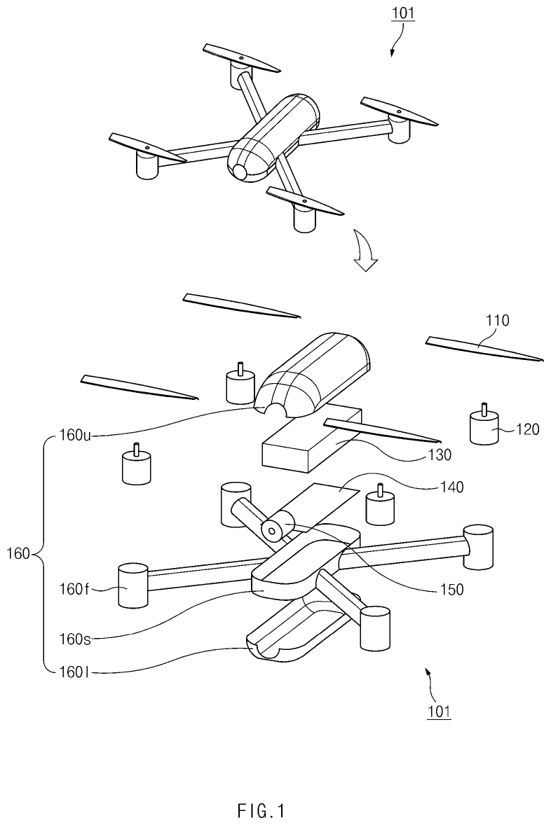

FIG. 1 illustrates a perspective view and an exploded perspective view of a UAV, according to an embodiment.

According to an embodiment, a UAV 101 according to an embodiment may include a propeller 110, a motor 120, a battery 130, a circuit board 140, a camera 150, and housing 160. According to various embodiments, the UAV 101 may further include components not illustrated in FIG. 1 or may not include a part of the components illustrated in FIG. 1.

According to an embodiment, the propeller 110 may be connected to the motor 120 and may rotate in synchronization with the rotation of the motor 120 to generate lift force. The UAV 101 may float in the air by the lift force. The UAV 101 may fly in a horizontal direction and/or a vertical direction with respect to the ground, under the control of the rotation of the motor 120.

According to an embodiment, the battery 130 may supply power to various circuits, a module, or the like included in the UAV 101, as well as the motor 120, the circuit board 140, and the camera 150. According to an embodiment, various circuits, such as a processor, a memory, a sensor, and the like, a module, or the like may be mounted on the circuit board 140.

According to an embodiment, the camera 150 may be electrically connected to the circuit board 140 to capture an image (still image) and/or a video. According to various embodiments, an actuator (e.g., a gimbal motor) for controlling the field of view (FoV) of the camera 150 may be coupled with the camera 150.

According to an embodiment, the housing 160 may protect each component included in the UAV 101 from dust, water, and external impact, and may physically support each of the components. For example, the housing 160 may be formed of metal, plastic, a polymeric material, or a combination thereof.

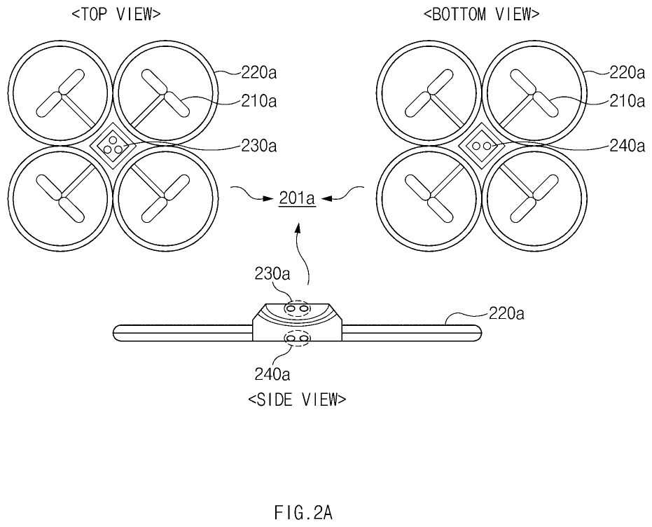

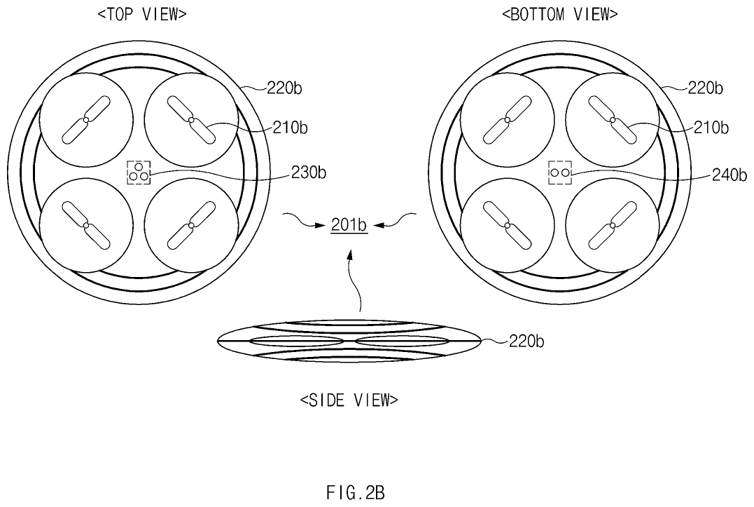

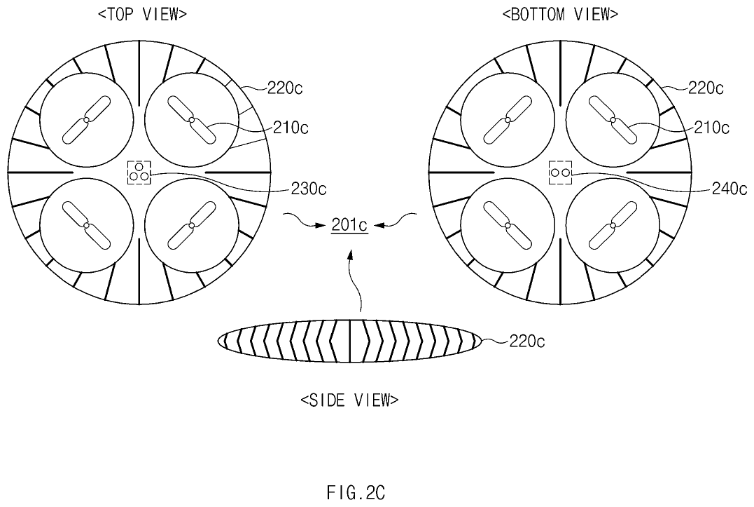

According to an embodiment, the housing 160 may include an upper housing 160u, a lower housing 1601, a side housing 160s, and a frame 160f. However, the configuration of the housing 160 is not limited to an example illustrated in FIG. 1. For example, as illustrated in FIG. 2, the UAV may include the housing having various shapes.

According to an embodiment of the disclosure, a tactile sensor for recognizing the touch from a user may be disposed on the surface of at least part of the housing 160. The tactile sensor may be configured to detect whether the touch is present, a location at which the touch is made, the pressure of the touch, or the like.

FIGS. 2A to 2C illustrate a top view, a bottom view, and a side view of a UAV, according to various embodiments.

The top view, bottom view, and side view of UAVs 201a, 201b, and 201c according to various embodiments are displayed in FIGS. 2A to 2C, respectively. The appearances of UAVs 201a, 201b, and 201c illustrated in FIGS. 2A to 2C are exemplary; various embodiments of the disclosure are not limited to the illustration of FIGS. 2A to 2C. For example, as in the UAV 101 illustrated in FIG. 1, there are UAVs with a wide variety of appearances. The description the same as that described with reference to FIGS. 2A to 2C is omitted.

According to the top view of the UAV 201a illustrated in FIG. 2A, four propellers 210a, housing 220a, and various hardware components 230a may be exposed in the top view. Each of the four propellers 210a may be coupled with the rotor axis of the corresponding motor. The housing 220a may include protection rims respectively surrounding the four propellers 210a and body housing. The tactile sensor according to various embodiments of the disclosure may be disposed on the exterior surface of the housing 220a. For example, the first tactile sensor may be disposed on the exterior surface of the housing 220a, that is, at least part of the upper surface. For example, a power button, a hovering start button, and/or a distance measurement sensor for measuring the distance to an external object may be disposed in the various hardware components 230a.

According to the bottom view of the UAV 201a illustrated in FIG. 2A, the four propellers 210a, the housing 220a, and the various hardware components 240a may be exposed in the bottom view. The second tactile sensor according to various embodiments of the disclosure may be disposed on at least part of the lower surface of the housing 220a. A camera, a distance measurement sensor (e.g., infrared, ultrasonic) for measuring the distance to the ground, and the like may be disposed in the various hardware components 240a. According to various embodiments, modules with specific purposes disposed under the UAV 201a may be referred to as “payload”.

According to the side view of the UAV 201a illustrated in FIG. 2A, the four propellers 210a, the housing 220a, and the various hardware components 230 and 240a may be exposed in the side view. The third tactile sensor according to various embodiments of the disclosure may be disposed on at least part of the side surface of the housing 220a. A distance measurement sensor for measuring a distance to an external object may be disposed on the side surface of the housing 220a.

According to the top view of the UAV 201b illustrated in FIG. 2B, four propellers 210b, housing 220b, and various hardware components 230b may be exposed in the top view. The housing 220b may surround the four propellers 210a. The tactile sensor according to various embodiments of the disclosure may be disposed on the exterior surface of the housing 220b. For example, the first tactile sensor may be disposed in the form of a ring on at least part of the upper surface of the housing 220b.

According to the bottom view of the UAV 201b, the four propellers 210b, the housing 220b, and the various hardware components 240b may be exposed in the bottom view. The second tactile sensor according to various embodiments of the disclosure may be disposed in the form of a ring on the part of the lower surface of the housing 220b.

According to the side view of the UAV 201b, the housing 220b may be exposed in the side view. The third tactile sensor according to various embodiments of the disclosure may be disposed on at least part of the side surface of the housing 220b.

A UAV 201c illustrated in FIG. 2c may include propellers 210c, housing 220c, and various hardware components 230c and 240c. The top view, bottom view, and side view of the UAV 201c may correspond to the top view, bottom view, and side view illustrated in FIG. 2B, respectively. However, the pattern layout of the tactile sensor of the housing 220c illustrated in FIG. 2C may be different from that of FIG. 2B. The tactile sensors disposed on most of the upper surface, the lower surface, and the side surface of the housing 220c may have vertical patterns.

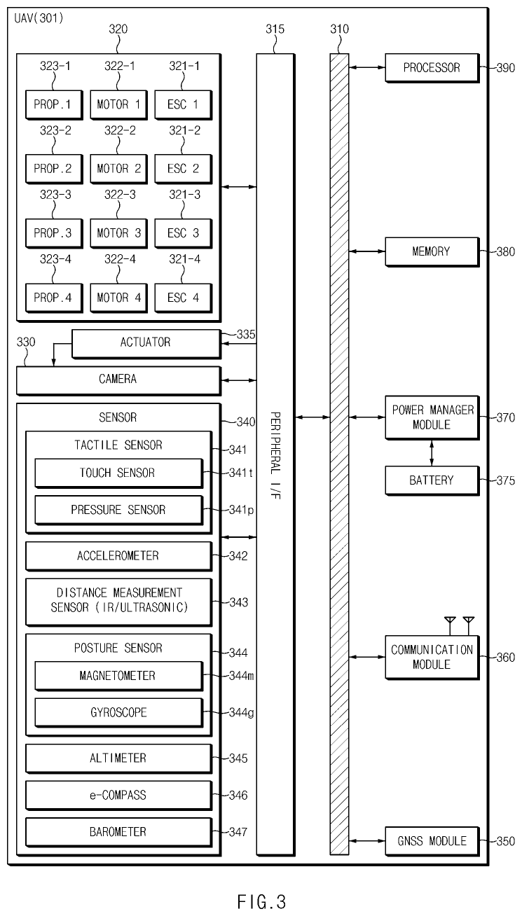

FIG. 3 illustrates a configuration of a UAV, according to an aspect.

Referring to FIG. 3, a UAV 301 according to an embodiment may include a bus 310, a peripheral interface 315, a flight driver 320, a camera 330, a sensor 340, a global navigation satellite system (GNSS) module 350, a communication module 360, a power manager module 370, a battery 375, a memory 380, and a processor 390. The UAV 301 may further include components not illustrated in FIG. 3 or may not include a part of the components illustrated in FIG. 3.

For example, the bus 310 may interconnect the components included in the UAV 301 and may include a circuit for conveying communication (e.g., a control message and/or data) among the components.

The peripheral interface (peripheral I/F) 315 may be connected to the bus 310 to be electrically connected to the flight driver 320, the camera 330, and the sensor 340. In addition to the camera 330 and the sensor 340, various modules (so-called payload) may be connected to the peripheral interface 315 depending on the usage purpose of the UAV 301.

The flight driver 320 may include electronic speed controls (ESCs) 321-1, 321-2, 321-3, and 321-4 (collectively referred to as 321), motors 322-1, 322-2, 322-3, and 322-4 (collectively referred to as 322), and propellers 323-1, 323-2, 323-3, and 323-4 (collectively referred to as 323). A control command (e.g., a pulse width modulation (PWM) signal) generated by the processor 390 may be transmitted to the ESC 321 via the bus 310 and the peripheral interface 315, and the ESC 321 may control the drive and rotation speed of the motor 322 depending on the control command. The propeller 323 may generate lift force by rotating in synchronization with the rotation of the motor 322.

The camera 330 may capture the image (a still image) and video of a subject. According to an embodiment, the camera module 330 may include one or more lenses, an image sensor, an image signal processor, or a flash (e.g., a light emitting diode, a xenon lamp, or the like). According to an embodiment, the camera 330 may include an optical flow sensor (OFS). The OFS may detect the flight flow (movement) of the UAV 301, using the relative motion patterns of the recognized object, surface, corner, and the like.

An actuator 335 may control the FoV of the camera 330 under the control of the processor 390. For example, the actuator 335 may include a 3-axis gimbal motor.

The sensor module 340 may include a tactile sensor 341, an accelerometer 342, a distance measurement sensor 343, a posture sensor 344, an altimeter 345, an e-compass 346, and a barometer 347. The various sensors 341 to 347 in FIG. 3 are exemplary and are not limited thereto. In addition to the sensors illustrated in FIG. 3, various sensors may be included in the sensor module 340.

The tactile sensor 341 may include may include a touch sensor 341t and a pressure sensor 341p. The tactile sensor 341 may detect whether the touch from a user is present, a location at which the touch is made, the pressure of the touch, or the like. According to an embodiment, the tactile sensor 341 may be disposed on at least part of the surface of the housing. For example, the tactile sensor 341 may be disposed on the upper surface of the housing (hereinafter referred to as a “first tactile sensor”), may be disposed on the lower surface of the housing (hereinafter referred to as a “second tactile sensor”), and may be disposed on the side surface of the housing (hereinafter referred to as a “third tactile sensor”).

The distance measurement sensor 343 may measure the distance to an external object (e.g., a wall, an obstacle, or a ceiling) at a periphery (up-side, down-side, left-side, and right-side) of the UAV 301. The distance measurement sensor 343 may use ultrasonic waves or infrared rays as the medium (or parameter) for measuring the distance.

The posture sensor 344 may detect the posture in the three-dimensional space of the UAV. The posture sensor 344 may include a 3-axis geomagnetic sensor 344m and/or a 3-axis gyroscope sensor 344g.

The altimeter 344 may measure the altitude of the UAV 301. The altimeter 344 may measure the altitude using the radar or may measure the altitude, at which the UAV 301 is located, using the barometric pressure measured by the barometer 347. The e-compass 347 may measure the orientation to support the flight of the UAV 301.

The GNSS module 350 may communicate with a satellite to obtain information about the latitude and longitude at which the UAV 301 is located. For example, the GNSS may include a global positioning system (GPS), a global navigation satellite system (Glonass), Beidou Navigation Satellite System (hereinafter referred to as “Beidou”), or the European global satellite-based navigation system (Galileo). In this specification, “GPS” and “GNSS” may be used interchangeably.

For example, the communication module 360 may support the communication channel establishment between the UAV 301 and an external device and the execution of wired or wireless communication through the established communication channel. According to an embodiment, for example, the communication module 360 may support cellular communication or short range wireless communication.

The cellular communication may include, for example, long-term evolution (LTE), LTE Advance (LTE-A), code division multiple access (CMA), wideband CDMA (WCDMA), universal mobile telecommunications system (UMTS), wireless broadband (WiBro), or global system for mobile communications (GSM). The short range wireless communication may include, for example, wireless fidelity (Wi-Fi), Wi-Fi Direct, light fidelity (Li-Fi), Bluetooth, infrared data association (IrDA), Bluetooth low energy (BLE), ZigBee, near field communication (NFC), magnetic secure transmission (MST), radio frequency (RF), or body area network (BAN).

The power manager module 370 may be a module for managing the power of the UAV 301 and may include, for example, a power management integrated circuit (PMIC). The power manager module 370 may manage the charging and discharging of the battery.

The battery 375 may convert chemical energy and electrical energy bidirectionally. For example, the battery 375 may convert chemical energy into electrical energy and may supply the converted electrical energy to various components or modules mounted in the UAV 301. The battery 375 may convert and store electrical energy from the outside into chemical energy.

The memory 380 may include a volatile and/or nonvolatile memory. For example, the memory 380 may store commands or data associated with components included in the UAV 301.

The processor 390 may include one or more of a central processing unit (CPU), an application processor (AP), a communication processor (CP), and a graphic processing unit (GPU). For example, the processor 390 may be electrically connected to at least one of other components of the UAV 301 to perform data processing or an operation associated with control or communication.

According to an aspect of the disclosure, the processor 390 may move the reference location of a hovering operation by the UAV 301 from a first location to a second location, based on whether a touch from a user is present, or the pressure of the touch.

According to an embodiment, the processor 390 may control the at least one motor 322 such that the UAV 301 performs the hovering operation at the first location. The hovering operation may mean an operation in which the UAV 301 is hovering at a specified location (or altitude) in consideration with the effect by the external force (e.g., wind, or the like). For example, the UAV 301 performing the hovering operation may limit the substantially horizontal and vertical movements (with respect to the ground) so as to hover at the specified location despite the external force. The first location may be specified in advance, as an example of the specified location.

According to an embodiment, when the touch is sensed by the tactile sensor 341, the processor 390 may release the limitation of one of horizontal movement or vertical movement of the UAV 301. For example, when the touch is sensed by the tactile sensor 341 (the first tactile sensor) disposed on the upper surface of the housing or the tactile sensor 341 (the second tactile sensor) disposed on the lower surface of the housing, the processor 390 may release the limitation of the vertical movement (altitude change). For still another example, when the touch is sensed by the tactile sensor 341 (the third tactile sensor) disposed on the side surface of the housing, the limitation of horizontal movement may be released. The location where the hovering operation was performed previously, i.e., the first location may be changed to the second location through the release of the movement limitation.

According to an embodiment, the processor 390 may determine the second location different from the first location, based on the touch sensed by the tactile sensor 341.

For example, when the touch is sensed by the first tactile sensor, the processor 390 may determine a location having an altitude lower than an altitude of the first location, as the second location. For another example, when the touch is sensed by the second tactile sensor, the processor may determine a location having an altitude higher than an altitude of the first location, as the second location. That is, when the touch is sensed by the first tactile sensor or the second tactile sensor, the altitude of the reference location of the hovering operation may be changed.

For still another example, when the touch is sensed by the third tactile sensor, the processor 390 may determine another location having an altitude the same as the first location, as the second location. At this time, the direction from the first location to the second location may correspond to a horizontal component of a direction to which the touch is applied. That is, when the touch is sensed by the third tactile sensor, the reference location of the hovering operation may be changed in a horizontal direction.

According to an embodiment, the distance “D” between the first location and the second location may be set in advance by the processor 390. For example, the hovering location of the UAV 301 may be changed in proportion to the number of times that the touch is sensed by the tactile sensor 341. For example, while the UAV 301 performs the hovering operation at the first location, when the touch is sensed four times by the tactile sensor 341, the changed reference location (the second location) of the hovering operation may be spaced from the first location by 4D.

According to an embodiment, the processor 390 may determine the distance between the first location and the second location, depending on the pressure of the touch sensed by the tactile sensor 341. According to an embodiment, the tactile sensor 341 may include the pressure sensor 341p. When the pressure sensed by the pressure sensor 341p is high, the processor 390 may determine that the distance between the first location and the second location is long. On the other hand, when the sensed pressure is low, the processor 390 may determine that the distance between the first location and the second location is short. According to various embodiments, the sensed pressure is excessively high, the distance between the first location and the second location may be limited to a specific level.

According to an embodiment, the processor 390 may control the at least one motor 322 such that the UAV 301 performs the hovering operation at the determined second location.

According to various embodiments, the processor 390 may control at least one motor 322 such that the distance between the second location and the external object is not less than a specified value, based on the distance to an external object (e.g., a wall, an obstacle, or a ceiling), which is measured by the distance measurement sensor 343. The specified value may correspond to the size of the UAV 301. In this way, even though the touch with the strong pressure is detected, the UAV 301 may not collide with an external object.

According to various embodiments, while the UAV 301 moves from the first location to the second location, the processor 390 may control the camera 330 and/or actuator 335. For example, while the UAV 301 moves from the first location to the second location, the processor 390 may allow the camera 330 and/or actuator 335 to track the recognized subject. Furthermore, the processor 390 may control the actuator 335 such that the camera 330 captures an image and or video focusing on the subject.

According to another aspect of the disclosure, the processor 390 may move the reference location of a hovering operation by the UAV 301 from a first location to a second location intended by the user, based on a specified touch gesture (e.g., grab or grip) from the user.

According to an embodiment, the processor 390 may control the at least one motor 322 such that the UAV 301 performs the hovering operation at the first location. For example, the UAV 301 performing the hovering operation may limit the substantially horizontal and vertical movements so as to hover at the first location despite the external force. The first location may be specified in advance, as an example of the specified location.

According to an embodiment, when the specified touch (e.g., grab) is sensed by the tactile sensor 341, the processor 390 may release the limitation of both the vertical movement and horizontal movement of the UAV 301 and may reduce the output (e.g., the rotational speed of a rotor) of the at least one motor 322 to be less than or equal to a specified output value (e.g., 70% of the existing output value). For example, when the specified touch of the user grabbing the UAV 301 is sensed, the processor 390 may stop the hovering operation at the first location (i.e., may release the limitation of both the vertical movement and horizontal movement). The processor 390 may reduce the output (e.g., the rotational speed of a rotor) of the motor 322 to be less than or equal to a specified output value such that the user easily moves the UAV 301 to another location.

According to an embodiment, whether the specified touch (e.g., grab) is sensed may be determined in various manners. For example, when the touch including the contact of a specified area or more is sensed by the tactile sensor 341, the processor 390 may determine whether the specified touch is sensed. For still another example, when the touch including the contact during a specified time or longer is sensed by the tactile sensor 341, the processor 390 may determine whether the specified touch is sensed. For still another example, when the touch is sensed substantially simultaneously by two or more of the tactile sensor 341 (the first tactile sensor) disposed on the upper surface of the housing, the tactile sensor 341 (the second tactile sensor) disposed on the lower surface of the housing, and the tactile sensor 341 (the third tactile sensor) disposed on the side surface of the housing, the processor 341 may determine whether the specified touch is sensed. The sensing method of the specified touch is exemplary and is not limited thereto. For example, the tactile sensor 341 may include a dedicated sensor for sensing the specified touch.

According to an embodiment, when the acceleration value detected by the accelerometer 342 is reduced to a specified value or less, the processor 390 may increase the output of the at least one motor 322 to the specified output value or more, to perform the hovering operation at the second location. The second location may correspond to a location in a space of the UAV 301 at a point in time when the acceleration value is reduced to a specified value or less (substantially ‘0’).

For example, for the purpose of allowing the UAV 301 performing the hovering operation at the first location to perform the hovering operation at the second location, the user may grab the UAV 301 and then may put the UAV 301 at the second location. The acceleration value of the accelerometer 342 included in the UAV 301 may fluctuate greatly due to the grab and movement by the user. Accordingly, when the acceleration value is reduced to the specified value or less (substantially ‘0’), the UAV 301 may be regarded as being put at the second location intended by the user.

According to various embodiments, the processor 390 may initiate the hovering operation at the second location, additionally in consideration of posture in the space of the UAV 301 in addition to the acceleration value. For example, when the acceleration value sensed by the accelerometer 342 is reduced to the specified value or less and the posture of the UAV 301 measured by the posture sensor 344 is horizontal with respect to the ground, the processor 390 may increase the output of the motor 322 so as to perform the hovering operation at the second location. In this way, when the UAV 301 is put in the posture not suitable for the hovering operation, the hovering operation may not be initiated.

According to various embodiments, after the acceleration value sensed by the accelerometer 342 is reduced to the specified value or less and then a specified time elapses, the processor 390 may initiate the hovering operation at the second location. Because the hovering operation (the rise in the motor output) is initiated after the specified time (e.g., 2-3 seconds) has elapsed, the processor 390 may accurately determine whether the current location of the UAV 301 is the hovering reference location intended by the user.

According to various embodiments, while the UAV 301 moves from the first location to the second location, the processor 390 may control the camera 330 and/or actuator 335.

For example, while the UAV 301 performs the hovering operation at the first location, the camera 330 may capture an image and/or video. While the UAV 301 moves from the first location to the second location, the processor 390 may allow the camera 330 to hold or pause the capture.

Afterward, when the hovering operation is initiated at the second location, the processor 390 may resume the capture. When the UAV 301 moves to the second location, after the processor 390 allows the camera 330 to initiate the image capture and to initiate the track for subject, the processor 390 may allow the camera 330 to apply the specified image processing effect (e.g., close-up, a Selfie filter, or the like).

The above-described operations of the processor 390 are, but are not limited to, an example. For example, any other operations of a processor described in this specification should be understood as operations of the processor 390. Also, in this specification, at least part of operations described as operations of an “electronic device” should be understood as operations of the processor 390. Moreover, according to various embodiments, all or part of the operations of the processor 390 may be performed by a separately provided controller for controlling the flight state.

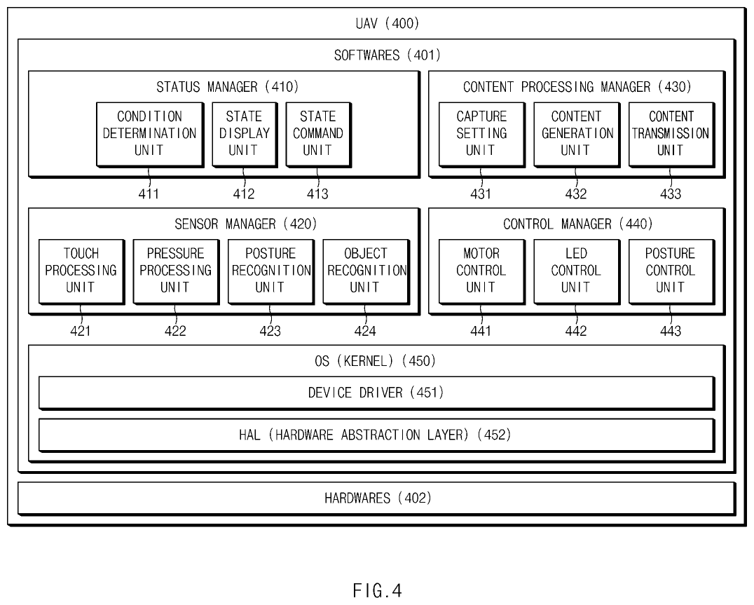

FIG. 4 illustrates a configuration of a UAV, according to another aspect.

Referring to FIG. 4, a UAV 400 according to an aspect may include software 401 and hardware 402. The software 401 may be implemented in a (volatile) memory by the computing resources of the processor. Accordingly, the operation of the software 401 described below may be understood as the operation of the processor. For example, the hardware 402 may include the various components illustrated in FIG. 3.

According to an embodiment, the software 401 may include a status manager 410, a sensor manager 420, a content processing manager 430, a control manager 440, and an operating system (OS) 450.

The status manager 410 may determine the state transition condition based on the values provided from the sensor manager 420 and may change the operating state of the UAV 400 depending on the determination result.

According to an embodiment, the status manager 410 may include a condition determination unit 411, a state display unit 412, and a state command unit 413. The condition determination unit 411 may determine whether a specified state transition condition is satisfied, based on the values provided from the sensor manager 420. When the operating state of the UAV 400 is changed depending on the determination result of the condition determination unit 411, the state display unit 412 may notify the user of the changed operating state through a speaker, an LED, a display, or the like. The state command unit 413 may generate commands, signals, data, or information defined in the current operating state and may transmit the commands, the signals, the data, or the information to other components.

The sensor manager 420 may process sensing values received from various sensors to provide the sensing values to other components. For example, the sensor manager 420 may include a touch processing unit 421, a pressure processing unit 422, a posture recognition unit 423, and an object recognition unit 424.

According to an embodiment, the touch processing unit 421 may provide the status manager 410 with the touch data (a touch location, a touch type, or the like) sensed by the touch sensor included in the tactile sensor. The pressure processing unit 422 may provide the status manager 410 with the pressure value (the intensity of pressure, or the like) sensed by the pressure sensor included in the tactile sensor. The posture recognition unit 423 may obtain sensing data (the slope of UAV, the height from the ground, absolute altitude, GPS location information, or the like) associated with the location and/or posture of the UAV 400 from a posture detection module, a GPS (GNSS) module, an altimeter, or the like to provide the sensing data to the status manager 410. The object recognition unit 424 may distinguish a user's palm from the general object to recognize the user's palm. The recognition data of the palm may be provided to the status manager 410. The recognition data of the palm may be used to determine the condition for reaching the “Palm Landing Try” state described below.

The content processing manager 430 may include a capture setting unit 431, a content generation unit 432, and a content transmission unit 433. The content processing manager 430 may manage the capture condition of a camera, data generation of the image and/or video obtained from the camera, and the transmission of the generating data.

According to an embodiment, the capture setting unit 431 may manage the setting of the capture condition of a camera. For example, the capture setting unit 431 may adjust the brightness, sensitivity, focal distance, or the like of the image and/or video or may change the capture mode (e.g., Selfie, Fly Out, or the like) depending on the flight state of the UAV 400. For example, the content generation unit 432 may generate or correct data (file) of the captured image and/or video using an image signal processor (ISP). The content transmission unit 433 may store the data (file) of the image and/or video generated by the content generation unit 432, in the memory of the UAV 400 or may transmit the data (file) to another electronic device via a communication module (e.g., Bluetooth, Wi-Fi Direct, or the like). The content transmission unit 433 may stream images obtained from the camera in real time, to an electronic device via the communication module (so called, a live view).

The control manager 440 may perform power control associated with the flight of the UAV 400. According to an embodiment, the control manager 440 may include a motor control unit 441, an LED control unit 442, and a posture control unit 443.

According to an embodiment, the motor control unit 441 may control the rotational speeds of a plurality of motors, based on the state determined by the status manager 410. For example, the motor control unit 441 may control the flight state (rotational states and/or translational states) of the UAV 400, by controlling the rotational speeds of the plurality of motors. The LED control unit 442 may receive state information from the state display unit 412 of the status manager 410 to control the color and blink speed of an LED. The posture control unit 443 may obtain the posture information of the UAV 400 from the posture recognition unit 424 of the sensor manager 420 and may perform the overall posture control of the UAV 400.

The kernel of the OS 450 may provide an interface for controlling or managing system resources (e.g., the hardware 402) used to execute the operations or functions implemented in the managers 410 to 440. The kernel may manage access to system resources (e.g., the hardware 402) of the managers 410 to 440. To this end, the kernel may include, for example, a device driver 451 and a hardware abstraction layer (HAL) 452.

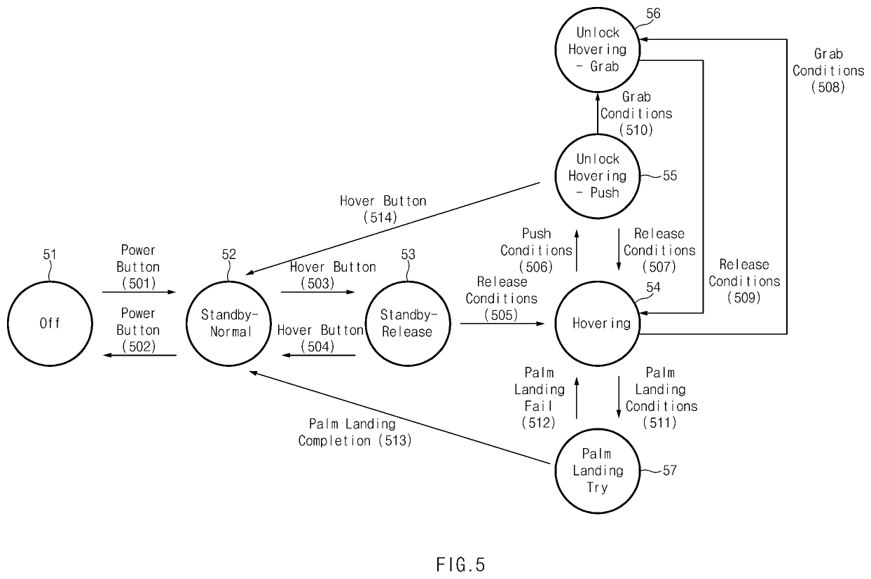

FIG. 5 illustrates a state diagram of a UAV, according to an embodiment.

Referring to FIG. 5, the operating state of the UAV according to an embodiment may include an Off state 51, a Standby-Normal state 52, a Standby-Release state 53, a Hovering state 54, a Unlock Hovering-Push state 55, a Unlock Hovering-Grab state 56, and a Palm Landing Try state 57. Each of the states 51 to 57 may be transitioned to another state when specific conditions described below are satisfied.

The Off state 51 may indicate the state where the UAV is powered off. For example, when a power button is pressed, the Standby-Normal state 52 may be transitioned (condition 501); when the power button is pressed again in the Standby-Normal state 52, the Off state 51 may be transitioned (condition 502).

The Standby-Normal state 52 may indicate the state where the UAV is powered on. In the Standby-Normal state 52, the propeller of the UAV may not rotate. For example, when a Hover button is pressed, the Standby-Release state 53 may be transitioned (condition 503); when the Hover button is pressed again in the Standby-Release state 53, the Standby-Normal state 52 may be transitioned (condition 504).

In the Standby-Release state 53, the UAV may increase the rotational speed (e.g., 300 RPM) of a propeller so as to perform a hovering operation. The Standby-Release state 53 may indicate the state until the UAV reaches the specified location (the first location). At this time, the UAV may turn on an LED indicating a self-operating mode (so-called a standalone mode). In the Standby-Release state 53, the UAV may continuously monitor the Release Conditions (condition 505); when the Release Conditions (condition 505) are satisfied, the hovering state 54 may be transitioned. The Release Conditions (condition 505) may include whether the posture, movement, and altitude, which are suitable such that the UAV performs a stable hovering operation, are maintained, and whether the stable posture, movement, or altitude is maintained during a specified time or longer.

The Hovering state 54 may indicate the state where the UAV flies while maintaining the specified location (and altitude). According to an embodiment, the UAV may automatically capture the image and/or video while remaining in the Hovering state without user's manipulation command. According to an embodiment, in the Hovering state 54, the UAV may monitor Push Conditions (condition 506), Grab Conditions (condition 508), or Palm Landing Conditions (511).

For example, when the Push Conditions (condition 506) are satisfied, the Unlock Hovering-Push state 55 may be transitioned from the Hovering state 54. The Push Conditions (condition 506) may include whether the touch and/or the pressure of the touch is sensed by the tactile sensor disposed in the housing of the UAV.

For still another example, when the Grab Conditions (condition 508) are satisfied, the Unlock Hovering-Grab state 56 may be transitioned from the Hovering state 54. The Grab Conditions (condition 508) may determine whether the grab (the specified touch) is sensed by the tactile sensor disposed in the housing of the UAV. For example, when the touch having the specified area or more in the tactile sensor, the touch during a specified time or longer or the touch on two or more surface is sensed, the UAV may determine whether the grab is sensed.

For still another example, when the Palm Landing Conditions (condition 511) are satisfied, the Palm Landing Try state 57 may be transitioned from the Hovering state 54. The Palm Landing Conditions (condition 511) may include whether an object (e.g., a user's palm) is recognized during a specified time or longer.

After the touch and/or the pressure of the touch is sensed by the tactile sensor disposed in the housing of the UAV, i.e., after the Push Conditions (condition 506) are satisfied, the Unlock Hovering-Push state 55 may indicate the state of moving to the second location determined based on the touch and/or the pressure of the touch.

According to an embodiment, in the Unlock Hovering-Push state 55, the UAV may release the limitation of one of horizontal movement or vertical movement, depending on the location at which the touch is made. For example, when the touch is sensed by the tactile sensor (the first tactile sensor) disposed on the upper surface of the housing or the tactile sensor (the second tactile sensor) disposed on the lower surface of the housing, the UAV may release the limitation of the vertical movement (altitude change). For still another example, when the touch is sensed by the tactile sensor (the third tactile sensor) disposed on the side surface of the housing, the limitation of horizontal movement may be released.

In the Unlock Hovering-Push state 55, the UAV may move to the second location corresponding to the sensed touch and/or the sensed pressure of the touch. Afterward, the UAV may determine whether the posture, movement, and altitude, which are suitable to perform a stable hovering operation, are maintained and whether the stable posture, movement, or altitude is maintained during a specified time or longer (Release Conditions (condition 507)); when the Release Conditions (condition 507) are satisfied, the Hovering state 54 may be transitioned again.

According to various embodiments, in the Unlock Hovering-Push state 55, the UAV may continuously monitor whether the grab is sensed by the tactile sensor disposed in the housing of the UAV, i.e., the Grab Conditions (condition 510) are satisfied. For example, when the Grab Conditions (condition 510) are satisfied in the Unlock Hovering-Push state 55 after the touch is sensed, the Unlock Hovering-Grab state 56 may be transitioned.

According to various embodiments, when the user presses a Hover button in the Unlock Hovering-Push state 55 (condition 514), the Standby-Normal state 52 may be transitioned.

When the grab is sensed by the tactile sensor, i.e., the Grab Conditions (condition 510) are satisfied, the Unlock Hovering-Grab state 56 may indicate a state of reducing the output (e.g., the rotational speed of a rotor) of a motor to a specified output value or less such that the user easily moves the UAV to another location.

According to an embodiment, in the Unlock Hovering-Grab state 56, the limitation of both the vertical movement and horizontal movement of the UAV may be released. Afterward, the UAV may determine whether the posture, movement, and altitude, which are suitable to perform a stable hovering operation, are maintained and whether the stable posture, movement, or altitude is maintained during a specified time or longer (Release Conditions (condition 509)). When the Release Conditions (condition 509) are satisfied, the UAV may increase the output of a motor to the specified output value or more, and then the Hovering state 54 may be transitioned again.

The Palm Landing Try state 57 may indicate a state where the UAV recognizing an object (e.g., the user's palm) attempts to land on the object. In the Palm Landing Try state 57, the UAV may monitor whether the UAV stably lands on the object or whether the landing of the UAV is successful.

According to an embodiment, in the Palm Landing Try state 57, the UAV may determine that the landing on the object is successful, when the distance to the object is not greater than a specified distance (substantially ‘0’) (Palm Landing Completion (condition 513). According to another embodiment in the Palm Landing Try state 57, the UAV has attempted to land on the object the number of times. However, when the Palm Landing Completion (condition 513) is not satisfied (Palm Landing Fail (condition 512)), the Hovering state 54 may be transitioned again.

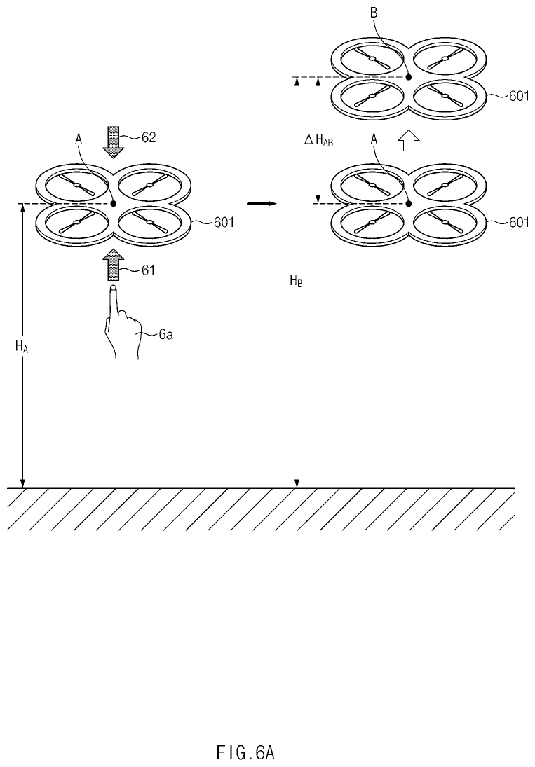

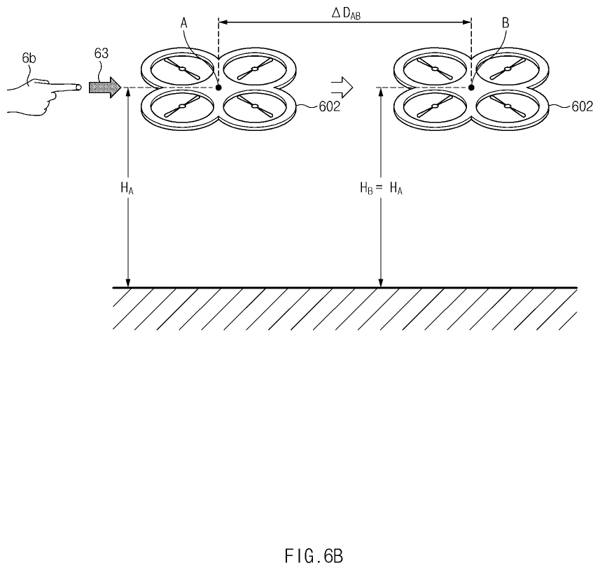

FIGS. 6A and 6B are views for describing a flight controlling method, according to an embodiment.

Referring to FIG. 6A, a UAV 601 performing a hovering operation at a location ‘A’ (altitude ‘HA’ from the ground) is illustrated. For example, at the location ‘A’, the UAV 601 may be in the Hovering state 54 illustrated in FIG. 5.

According to an embodiment, a user 6a may provide a user input 61 (e.g., touch) to a second tactile sensor disposed on the lower surface of the UAV 601. Because a user input, for example, the touch and the pressure of the touch, is sensed by the second tactile sensor (because Push Conditions (condition 506) illustrated in FIG. 5 are satisfied), the UAV 601 may release the limitation of the vertical movement and then may move to location ‘B’ (the Unlock Hovering-Push state 55 illustrated in FIG. 5).

According to an embodiment, the UAV 601 may determine a location ‘B’, based on the sensed touch. For example, the location ‘B’ (altitude ‘HB’ from the ground) may be determined as a location higher than the height ‘HA’ of the location ‘A’ by ΔHAB. For example, the ΔHAB may correspond to (e.g., may be proportional to) the intensity of the pressure of the touch 61 from the user 6a. For still another example, the ΔHAB may be determined in proportion to the number of sensed touches. In this case, the UAV 601 may be configured to move by a predefined distance in response to one touch. For example, when three touches are sensed, the ΔHAB may correspond to three times the predefined distance.

According to an embodiment, when the posture, movement, and altitude, which are suitable to perform a stable hovering operation, are maintained during a specified time or longer (the Release Conditions (condition 507) illustrated in FIG. 5 are satisfied), the UAV 601 moving to the location ‘B’ may perform the hovering operation at the location ‘B’ (the Hovering state 54 illustrated in FIG. 5).

An embodiment is exemplified in FIG. 6A as the user 6a touches (61) the second tactile sensor disposed on the lower surface of the UAV 601. However, an embodiment is not limited thereto. For example, the user 6a may change the hovering location of the UAV 601 to a location lower than the location ‘A’, by touching (62) the first tactile sensor disposed on the upper surface of the UAV 601.

Referring to FIG. 6B, a UAV 602 performing a hovering operation at the location ‘A’ (altitude ‘HA’ from the ground) is illustrated. For example, at the location ‘A’, the UAV 602 may be in the Hovering state 54 illustrated in FIG. 5.

According to an embodiment, a user 6b may provide a user input 63 (e.g., touch) to a third tactile sensor disposed on the side surface of the UAV 602. Because a user input, for example, the touch and the pressure of the touch, is sensed by the third tactile sensor (because Push Conditions (condition 506) illustrated in FIG. 5 are satisfied), the UAV 602 may release the limitation of the horizontal movement and then may move to location ‘B’ (the Unlock Hovering-Push state 55 illustrated in FIG. 5).

According to an embodiment, the UAV 602 may determine the location ‘B’, based on the sensed touch. For example, the location ‘B’ (altitude ‘HB’ from the ground) may be determined as a location, which is the same as the height ‘HA’ of the location ‘A’ (HA=HB) and is spaced by ΔDAB in the horizontal direction with respect to the ground. The direction from the location ‘A’ to the location ‘B’ may correspond to the horizontal direction component of the touch 63. According to various embodiments, the ΔDAB may be specified in advance or may correspond to the pressure of the touch 63 from the user 6b.

According to an embodiment, when the posture, movement, and altitude, which are suitable to perform a stable hovering operation, are maintained during a specified time or longer (the Release Conditions (condition 507) illustrated in FIG. 5 are satisfied), the UAV 601 moving to the location ‘B’ may perform the hovering operation at the location ‘B’ (the Hovering state 54 illustrated in FIG. 5).

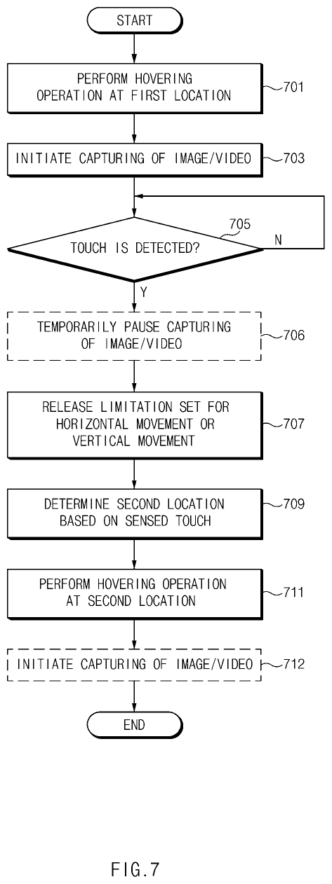

FIG. 7 is a flowchart illustrating a flight controlling method, according to an embodiment.

Referring to FIG. 7, the flight controlling method according to an embodiment may include operation 701 to operation 712. For example, operation 701 to operation 712 may be performed by the UAV 301 illustrated in FIG. 3. For example, operation 701 to operation 712 may be implemented with instructions or hardware logic capable of being performed (or executed) by the processor 390 of the UAV 301. Below, operation 701 to operation 712 will be described by using the reference numerals of FIG. 3.

In operation 701, the processor 390 of the UAV 301 may control the at least one motor 322 such that the UAV 301 performs a hovering operation at a first location (the Hovering state 54 of FIG. 5). The processor 390 may limit the horizontal and vertical movements such that the UAV 301 hovers at the first location.

In operation 703, the processor 390 may initiate the capturing of the image (still image) and/or video, using the camera 330.

In operation 705, the processor 390 may determine whether the touch is detected by the tactile sensor 341 disposed on the upper surface, the lower surface, and/or the side surface of housing. For example, the processor 390 may determine whether the Push Conditions (condition 506) illustrated in FIG. 5 are satisfied. The processor 390 may perform operation 706 when the touch is sensed by the tactile sensor 341; otherwise, the processor 390 may monitor whether the touch is sensed, by repeating operation 705.

In operation 706, the processor 390 may temporarily pause the capturing of the image and/or video in response to the detection of the touch. According to various embodiments, operation 706 may be skipped. When operation 706 is skipped, the capture initiated in operation 703 may be performed continuously.

When the touch is sensed by the tactile sensor 341, in operation 707, the processor 390 may release the limitation of one of horizontal movement or vertical movement of the UAV 301 (transition to the Unlock Hovering-Push state 55). For example, when the touch is sensed by the tactile sensor 341 (the first tactile sensor) disposed on the upper surface of the housing or the tactile sensor 341 (the second tactile sensor) disposed on the lower surface of the housing, the processor 390 may release the limitation of the vertical movement (altitude change). For still another example, when the touch is sensed by the tactile sensor 341 (the third tactile sensor) disposed on the side surface of the housing, the limitation of horizontal movement may be released.

In operation 709, the processor 390 may determine the second location different from the first location, based on the touch sensed by the tactile sensor 341.

For example, when the touch is sensed by the first tactile sensor, the processor 390 may determine a location having an altitude lower than an altitude of the first location, as the second location. For another example, when the touch is sensed by the second tactile sensor, the processor 390 may determine a location having an altitude higher than an altitude of the first location, as the second location. That is, when the touch is sensed by the first tactile sensor or the second tactile sensor, the altitude of the reference location of the hovering operation may be changed.

For still another example, when the touch is sensed by the third tactile sensor, the processor 390 may determine another location having an altitude the same as the first location, as the second location. At this time, the direction from the first location to the second location may correspond to a horizontal component of a direction to which the touch is applied. That is, when the touch is sensed by the third tactile sensor, the reference location of the hovering operation may be changed in a horizontal direction.

According to an embodiment, the distance between the first location and the second location may be determined in proportion to the number of times that the touch is sensed by the tactile sensor 341. In this case, the processor 390 may move the UAV 301 by a predefined distance in response to one touch. For example, when three touches are detected, the processor 390 may move the UAV 301 by three times the predefined distance.

According to still another embodiment, the processor 390 may determine the distance between the first location and the second location, depending on the pressure of the touch sensed by the tactile sensor 341. When the pressure sensed by the pressure sensor 341p included in the tactile sensor 341 is high, the processor 390 may determine that the distance between the first location and the second location is long; when the sensed pressure is low, the processor 390 may determine that the distance between the first location and the second location is short.

According to various embodiments, the processor 390 may control at least one motor 322 such that the distance between the second location and the external object is not less than a specified value, based on the distance to an external object (e.g., a wall, an obstacle, or a ceiling), which is measured by the distance measurement sensor 343.

In operation 711, the processor 390 may control the at least one motor 322 such that the UAV 301 performs the hovering operation at the second location determined in operation 709. For example, the processor 390 may determine whether Release Conditions (condition 507) illustrated in FIG. 5 are satisfied; when the Release Conditions (condition 507) are satisfied, the processor 390 may return to the Hovering state 54.

In operation 712, the processor 390 may initiate the capturing of the image and/or video.

According to various embodiments, when operation 706 is skipped, operation 712 may be also skipped. That is, the capture initiated in operation 703 may be continued. For example, while the UAV 301 moves from the first location to the second location, the processor 390 may allow the camera 330 and/or actuator 335 to track the recognized subject. The processor 390 may control the actuator 335 such that the camera 330 captures an image and or video focusing on the subject. In this way, various capture effects may be achieved.

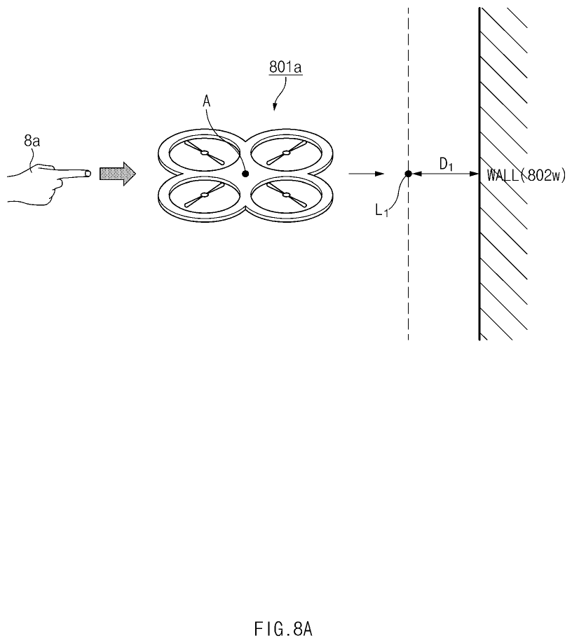

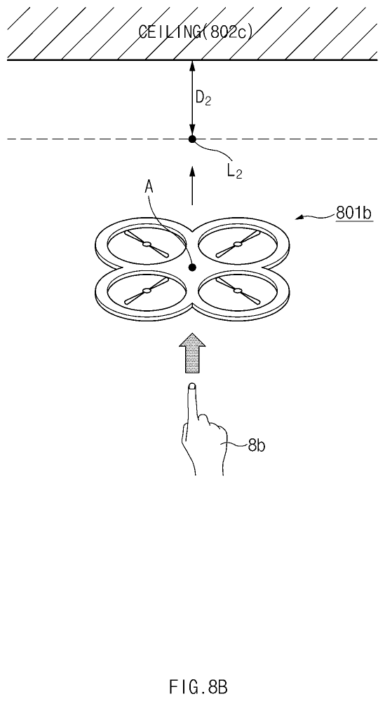

FIGS. 8A and 8B are flowcharts illustrating obstacle collision avoidance, according to an embodiment.

Referring to FIG. 8A, a user 8a may provide a user input (e.g., touch) to a third tactile sensor disposed on the side surface of a UAV 801a. Because a user input, for example, the touch and the pressure of the touch, is sensed by the third tactile sensor (because Push Conditions (condition 506) illustrated in FIG. 5 are satisfied), the UAV 801a may release the limitation of the horizontal movement and may determine a location ‘B’ to which the UAV 801a needs to move.

According to an embodiment, the location ‘B’ may be determined as a location, the altitude of which is the same as the altitude of a location ‘A’ and which is moved in the horizontal direction from the location ‘A’ by a distance corresponding to the pressure of the touch from the user 8a. However, for example, because the location ‘B’ may be determined as a location inside a wall 802w when the pressure of the touch is high, the UAV 801a may collide with the wall 802w when the UAV 801a moves to the location ‘B’.

Accordingly, according to an embodiment, the UAV 801a may measure the distance to the wall 802w, using a distance measurement sensor (an ultrasonic sensor, an infrared sensor, or the like) and may change the location ‘B’ such that the distance from the wall 802w is spaced by a specified value. For example, referring to FIG. 8A, the UAV 801a may change the location ‘B’ to location L1 so as to be spaced from the wall 802w by ‘D1’.

Referring to FIG. 8B, a user 8b may provide a user input (e.g., touch) to a second tactile sensor disposed on the lower surface of a UAV 801b. Because a user input, for example, the touch and the pressure of the touch, is sensed by the second tactile sensor (because Push Conditions (condition 506) illustrated in FIG. 5 are satisfied), the UAV 801b may release the limitation of the vertical movement and may determine the location ‘B’ to which the UAV 801b needs to move.

According to an embodiment, the location B may be determined as a location which rises in the vertical direction from the location ‘A’. For example, the location ‘B’ may be determined as a location which rises from the location ‘A’ by a distance corresponding to the pressure of the touch from the user 8b. However, for example, because the location ‘B’ may be determined as a location inside a ceiling 802c when the pressure of the touch is high, the UAV 801b may collide with the ceiling 802c when the UAV 801b moves to the location ‘B’.

Accordingly, according to an embodiment, the UAV 801b may measure the distance to the ceiling 802c, using a distance measurement sensor (an ultrasonic sensor, an infrared sensor, or the like) and may change the location ‘B’ such that the distance from the ceiling 802c is spaced by a specified value. For example, referring to FIG. 8B, the UAV 801b may change the location ‘B’ to location L2 so as to be spaced from the ceiling 802c by ‘D2’.

According to various embodiments, when the pressure of the touch detected by the UAV is excessively high, the distance between the location ‘A’ and the location ‘B’ to which the UAV needs to move may be limited in advance to a specific level.

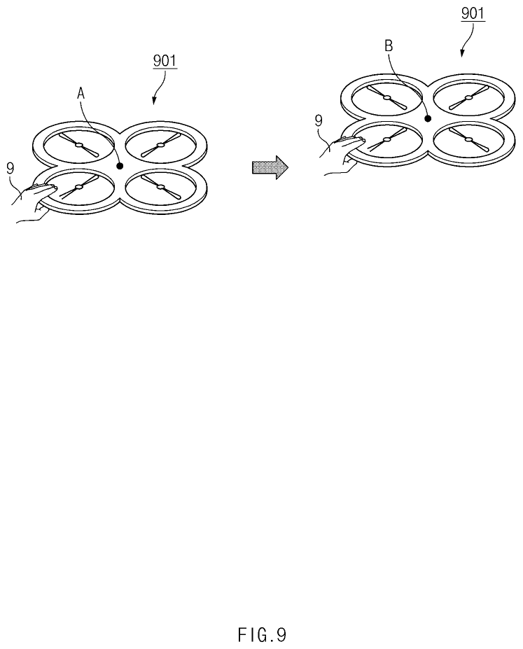

FIG. 9 is a view for describing a flight controlling method, according to another embodiment.

Referring to FIG. 9, a UAV 901 performing a hovering operation at a location ‘A’ is illustrated. For example, at the location ‘A’, the UAV 901 may be in the Hovering state 54 illustrated in FIG. 5.

According to an embodiment, a user 9 may grab the housing of the UAV 901, using his/her hand. When the touch of a specified area or more is sensed by the tactile sensor disposed in the housing, when the touch during a specified time or longer is sensed by the tactile sensor, or when the touch on two or more surfaces (e.g., the side surface and the lower surface) is sensed by the tactile sensor, the UAV 901 may determine that the grab by the user 9 is detected.

Because the grab by the user is detected (because the Grab Conditions (condition 508) illustrated in FIG. 5 are satisfied), the UAV 901 may release the limitation of vertical movement and horizontal movement and may reduce the output of a motor to a specified output value or less (the Unlock Hovering-Grab state 56 illustrated in FIG. 5).

According to an embodiment, after placing the UAV 901 at the location ‘B’, the user 9 may stand by for a while. When the posture, movement, and altitude, which are suitable to perform a stable hovering operation, are maintained during a specified time or longer (the Release Conditions (condition 509) illustrated in FIG. 5 are satisfied), the UAV 901 moving to the location 13′ may resume the hovering operation at the location ‘B’ by increasing the output of a motor (the Hovering state 54 illustrated in FIG. 5).

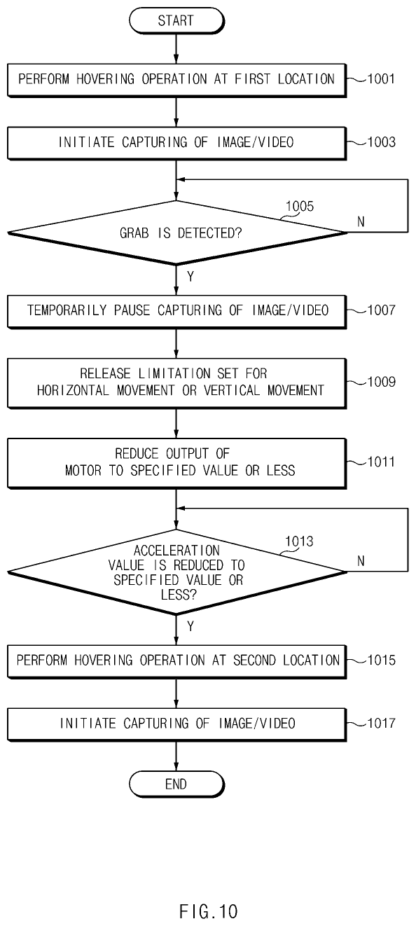

FIG. 10 is a flowchart illustrating a flight controlling method, according to another embodiment.

Referring to FIG. 10, the flight controlling method may include operation 1001 to operation 1017. For example, operation 1001 to operation 1017 may be performed by the UAV 301 illustrated in FIG. 3. For example, operation 1001 to operation 1017 may be implemented with instructions or hardware logic capable of being performed (or executed) by the processor 390 of the UAV 301. Hereinafter, operation 1001 to operation 1017 will be described by using the reference numerals of FIG. 3.

In operation 1001, the processor 390 of the UAV 301 may control the at least one motor 322 such that the UAV 301 performs a hovering operation at a first location (the Hovering state 54 of FIG. 5). The processor 390 may limit the horizontal and vertical movements such that the UAV 301 hovers at the first location. According to various embodiments, the processor 390 may be in a state (the Unlock Hovering-Push state 55 of FIG. 5) of moving by the (temporary) touch from a user in operation 1001.

In operation 1003, the processor 390 may initiate the capturing of the image (still image) and/or video, using the camera 330.

In operation 1005, the processor 390 may determine whether the specified touch (e.g., grab) is detected by the tactile sensor 341 disposed on the upper surface, the lower surface, and/or the side surface of housing. For example, the processor 390 may determine whether the Grab Conditions (condition 508 or 510) illustrated in FIG. 5 are satisfied. The processor 390 may perform operation 1006 when the touch is sensed by the tactile sensor 341; otherwise, the processor 390 may monitor whether the touch is sensed, by repeating operation 1005.

According to an embodiment, whether the specified touch (e.g., grab) is sensed may be determined in various manners. For example, when the touch including the contact of a specified area or more is sensed by the tactile sensor 341, the processor 390 may determine whether the specified touch is sensed. For still another example, when the touch including the contact during a specified time or longer is sensed by the tactile sensor 341, the processor 390 may determine whether the specified touch is sensed. For still another example, when the touch is sensed substantially simultaneously by two or more of the tactile sensor 341 (the first tactile sensor) disposed on the upper surface of the housing, the tactile sensor 341 (the second tactile sensor) disposed on the lower surface of the housing, and the tactile sensor 341 (the third tactile sensor) disposed on the side surface of the housing, the processor 341 may determine whether the specified touch is sensed. The sensing method of the specified touch is exemplary and is not limited thereto. For example, the tactile sensor 341 may sense the specified touch by including a dedicated sensor.

In operation 1007, the processor 390 may temporarily pause the capturing of the image and/or video in response to the specified touch (e.g., grab) of the touch.

In operation 1009, the processor 390 may release the limitation of both vertical movement and horizontal movement of the UAV 301. As such, the hovering operation at the first location may be paused (transition to the Unlock Hovering-Grab state 56).

In operation 1011, the processor 390 may reduce the output (e.g., the rotational speed of a rotor) of the at least one motor 322 to a specified output value or less such that the user easily moves the UAV 301 to another location (the second location).

In operation 1013, the processor 390 may determine whether the acceleration value detected by the accelerometer 342 is reduced to a specified value (substantially ‘0’) or less. For example, the processor 390 may determine whether the Release Conditions (condition 509) illustrated in FIG. 5 are satisfied. When the detected acceleration value is reduced to the specified value or less, the processor 390 may perform operation 1015; otherwise, the processor 390 may monitor the acceleration value by repeating operation 1013.

Because the acceleration value detected by the accelerometer 342 is reduced to the specified value or less, in operation 1015, the processor 390 may determine that the UAV 301 is positioned at the second location intended by the user. Afterward, the processor 390 may increase the output of the at least one motor 322 to the specified output value or more such that the UAV 301 performs the hovering operation at the second location.

According to an embodiment, in operation 1015, the processor 390 may initiate the hovering operation at the second location, additionally in consideration of posture in the space of the UAV 301 (the Hovering state 54 of FIG. 5). For example, when the acceleration value sensed by the accelerometer 342 is reduced to the specified value or less and the posture of the UAV 301 measured by the posture sensor 344 is horizontal with respect to the ground, the processor 390 may increase the output of the motor 322 so as to perform the hovering operation at the second location.

In operation 1017, when the hovering operation is initiated at the second location, the processor 390 may resume the capture. In this way, unnecessary operations such as a grab operation by the user may not be included in the image and/or video obtained through the camera 330 of the UAV 301.

According to various embodiments, when the UAV 301 moves to the second location, in operation 1017, after the processor 390 allows the camera 330 to initiate the image capture and to initiate the track for subject, the processor 390 may allow the camera 330 to apply the specified image processing effect.

In FIG. 10, the processor 390 may pause the capturing of the image and/or video in response to the detection of the grab by the user in operation 1007; the processor 390 may resume the capturing of the image and/or video in operation 1017. However, an embodiment is not limited thereto. According to various embodiments, operation 1007 and operation 1017 may be skipped. When operation 1007 and operation 1017 are skipped, the capture initiated in operation 1003 may be performed continuously.

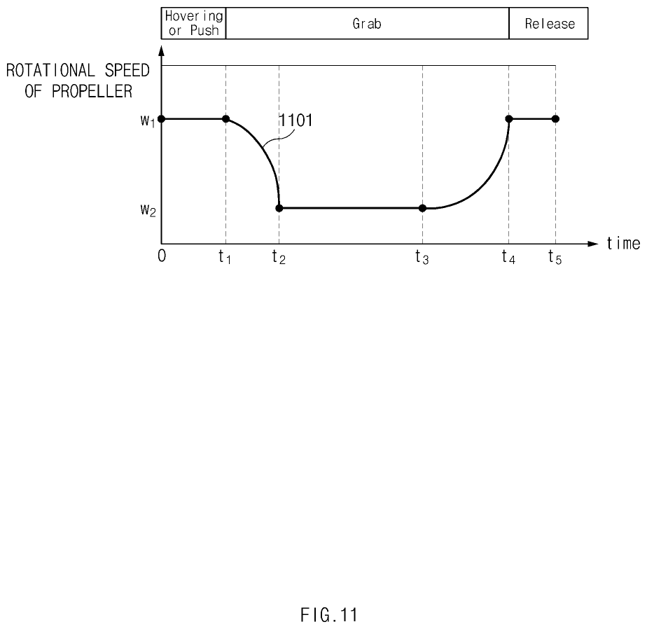

FIG. 11 is a graph illustrating a speed of a propeller in flight control, according to an embodiment.

Referring to FIG. 11, a graph 1101 illustrates the rotational speed change of the propeller for thrust control of a UAV according to one embodiment. In FIG. 11, the horizontal axis denotes time and the vertical axis denotes the rotational speed of a propeller. The description of FIG. 11 may be given using the reference numerals of FIG. 5.

At time t0 to time t1, the UAV may be in the Hovering state 54 or may be in the Unlock Hovering-Push state 55 in response to the touch from a user and/or the pressure of the touch. The rotational speed of the propeller for the thrust control may be maintained at w1.

For example, when the touch from the user and/or the touch pressure is detected in the Hovering state 54, the Unlock Hovering-Push state 55 may be transitioned (Push conditions (condition 506)). Alternatively, when the UAV maintains the stable posture, movement, and altitude in the Unlock Hovering-Push state 55, the Hovering state 54 may be transitioned again (Release conditions (condition 507)). In the Unlock Hovering-Push state 55, the UAV may release the limitation of vertical movement or horizontal movement.

At time t1, the user may grab the UAV. When the UAV detects the grab (the Grab Conditions (condition 508) are satisfied), the Unlock Hovering-Grab state 56 may be transitioned. The UAV may release the limitation of vertical movement and horizontal movement; from time t1 to time t2, the UAV may reduce the rotational speed of the propeller for the thrust control to a specified output value or less. In the Unlock Hovering-Grab state 56, the UAV may continuously monitor Release Conditions (condition 509).

From time t2 to time t3, while monitoring Release Conditions (condition 509), the UAV may maintain the rotational speed of the propeller for the thrust control to a specified output value or less (w2).

At time t3, when the posture, movement, and altitude, which are suitable to perform a stable hovering operation, are maintained during a specified time or longer (the Release Conditions (condition 509) are satisfied), the UAV may increase the rotational speed of the propeller for the thrust control to a specified output value or more from time t3 to time t4.

When the rotational speed of the propeller for the thrust control reaches a specific rotational speed w1 at time t4, the UAV may maintain the specific rotational speed w1. That is, the UAV may perform a hovering operation from time t4 (the Hovering state 54). Accordingly, the user may release the UAV at time t4.

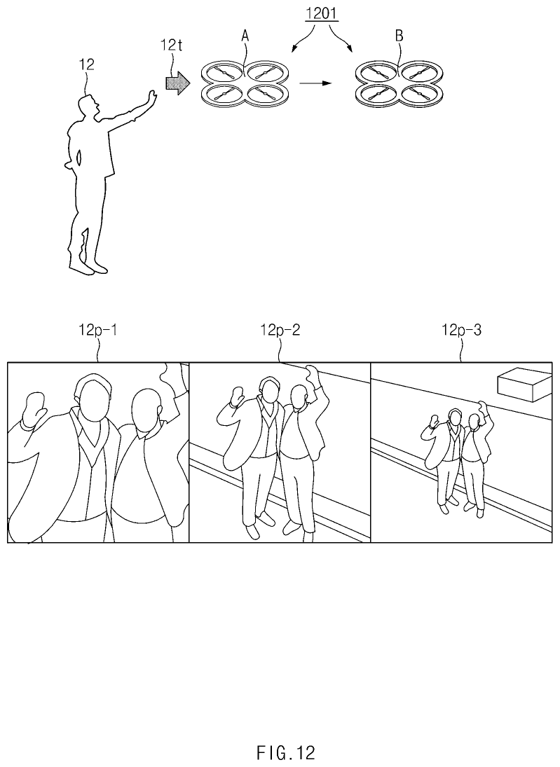

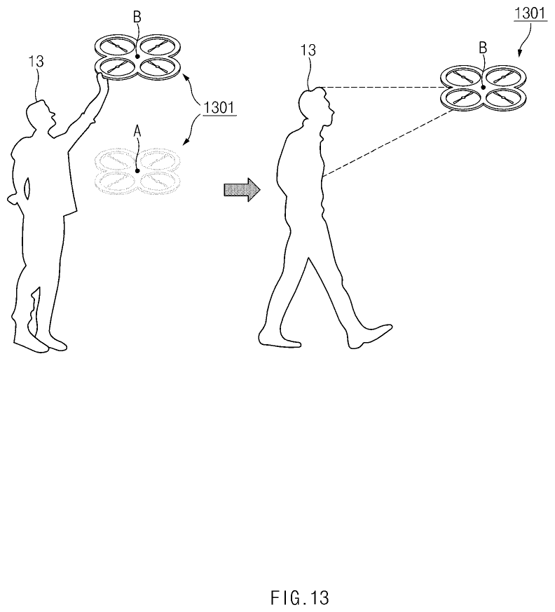

FIGS. 12 and 13 are views for describing camera control in flight control, according to an embodiment.

Referring to FIG. 12, a UAV 1201 including a camera for capturing the image or video for a subject is illustrated. According to an embodiment, the UAV 1201 may perform a hovering operation at a location ‘A’. For example, at the location ‘A’, the UAV 1201 may be in the Hovering state 54 illustrated in FIG. 5. While performing a hovering operation at the location ‘A’, the UAV 1201 may capture the image or video for a subject (e.g., a user 12), using a camera.

According to an embodiment, the user 12 may provide a user input 12t (e.g., touch) to a third tactile sensor disposed on the side surface of the UAV 1201. Because a user input, for example, the touch and the pressure of the touch, is sensed by the third tactile sensor (because Push Conditions (condition 506) illustrated in FIG. 5 are satisfied), the UAV 1201 may release the limitation of the horizontal movement and then may move to location ‘B’ (the Unlock Hovering-Push state 55 illustrated in FIG. 5).

According to an embodiment, while the UAV 1201 moves from the location ‘A’ to the location ‘B’, the UAV 1201 may track the subject (e.g., the user 12) and may control an actuator (e.g., a gimbal motor) connected to the camera such that a camera captures the image or video, focusing on the subject. According to various embodiments, while the UAV 1201 moves from the location ‘A’ to the location B, the UAV 1201 may apply ‘Fly Out’ capture mode automatically. Accordingly, for example, the subject may be captured in order of image 12p-1, image 12p-2, and image 12p-3.

Referring to FIG. 13, a UAV 1301 including a camera for capturing the image or video for a subject is illustrated. According to an embodiment, the UAV 1301 may perform a hovering operation at a location ‘A’. For example, at the location ‘A’, the UAV 1301 may be in the Hovering state 54 illustrated in FIG. 5. While performing a hovering operation at the location ‘A’, the UAV 1301 may capture the image or video for a subject (e.g., a user 13), using a camera.

According to an embodiment, a user 13 may grab the housing of the UAV 1301. Because the grab by the user is detected (because the Grab Conditions (condition 508) illustrated in FIG. 5 are satisfied), the UAV 1301 may release the limitation of vertical movement and horizontal movement and may reduce the output of a motor to a specified output value or less (the Unlock Hovering-Grab state 56 illustrated in FIG. 5). At this time, the UAV 1301 may temporarily pause the capturing of the camera.

According to an embodiment, after placing the UAV 1301 at the location ‘B’, the user 13 may stand by for a while. When the posture, movement, and altitude, which are suitable to perform a stable hovering operation, are maintained during a specified time or longer (the Release Conditions (condition 509) illustrated in FIG. 5 are satisfied), the UAV 1301 moved to the location 13′ may resume the hovering operation at the location ‘B’ by increasing the output of a motor (the Hovering state 54 illustrated in FIG. 5). The UAV 1301 may resume the capturing of the camera.

According to an embodiment, when the UAV 1301 resumes the hovering operation at the location ‘B’ after the UAV 1301 is moved to the location ‘B’, the UAV 1301 may allow the camera to initiate the capturing the image/video, to initiate the track for subject, and to apply the specified image processing effect (e.g., close-up, a Selfie filter, or the like).

According to various embodiments of the disclosure, even non-skilled persons may intuitively change the location of the UAV, without a separate controller. In this way, when an image or video is captured using the camera attached to the UAV, it is possible to easily obtain the view desired by a user.

According to an embodiment, a UAV may include housing, a tactile sensor disposed on at least a partial surface of the housing, at least one motor, a propeller connected the at least one motor, and a processor electrically connected to the tactile sensor and the at least one motor and controlling the at least one motor. The tactile sensor may include a first tactile sensor disposed on an upper surface of the housing, a second tactile sensor disposed on a lower surface of the housing, and a third tactile sensor disposed on a side surface of the housing. The processor may be configured to control the at least one motor such that the UAV performs a hovering operation at a first location, to release limitation of vertical movement when a touch is sensed by the first tactile sensor or the second tactile sensor, and release limitation of horizontal movement when a touch is detected by the third tactile sensor, to determine a second location different from the first location, based on the sensed touch, and to control the at least one motor such that the UAV performs a hovering operation at the second location.

According to an embodiment, the processor may be configured to determine a location having an altitude lower than an altitude of the first location, as the second location when the touch is sensed by the first tactile sensor and to determine a location having an altitude higher than the altitude of the first location, as the second location when the touch is sensed by the second tactile sensor.

According to an embodiment, a distance between the first location and the second location may be set in advance.

According to an embodiment, each of the first tactile sensor and the second tactile sensor may include a pressure sensor. The processor may be configured to determine a distance between the first location and the second location, depending on pressure of the touch.

According to an embodiment, the processor may be configured to determine a location having an altitude the same as the first location, as the second location when the touch is sensed by the third tactile sensor. A direction from the first location to the second location may correspond to a horizontal component of a direction to which the touch is applied.

According to an embodiment, a distance between the first location and the second location may be set in advance.

According to an embodiment, the third tactile sensor may include a pressure sensor. The processor may be configured to determine a distance between the first location and the second location, depending on pressure of the touch.

According to an embodiment, the UAV may further include a distance measurement sensor measuring a distance to an external object at a periphery of the UAV. The processor may be configured to control the at least one motor such that a distance between the second location and the external object is not less than a specified value.

According to an embodiment, a parameter used by the distance measurement sensor may include one of an ultrasonic wave and an infrared ray.

According to an embodiment, the UAV may further include a camera capturing a video for a subject and an actuator controlling a field of view (FoV) of the camera. The processor may be configured to track the subject while the UAV moves from the first location to the second location and to control the actuator such that the camera captures the video, focusing on the subject.

According to an embodiment, a UAV may include housing, a tactile sensor disposed on at least a partial surface of the housing, an accelerometer disposed inside the housing, at least one motor, a propeller connected the at least one motor, and a processor electrically connected to the tactile sensor and the at least one motor and controlling the at least one motor. The processor may be configured to control the at least one motor such that the UAV performs a hovering operation at a first location, to reduce an output of the at least one motor to a specified output value or less when a specified touch is sensed by the tactile sensor, and to increase the output of the at least one motor to the specified output value or more to perform a hovering operation at a second location when an acceleration value detected by the accelerometer is reduced to a specified value or less. The second location may correspond to a location of the UAV at a point in time when an acceleration value is reduced to a specified value or less.

According to an embodiment, the processor may be configured to determine that the specified touch is detected, when a touch including contact of a specified area or more is sensed by the tactile sensor.

According to an embodiment, the processor may be configured to determine that the specified touch is detected, when a touch including contact during a specified time or longer is sensed by the tactile sensor.

According to an embodiment, the tactile sensor may include a first tactile sensor disposed on an upper surface of the housing, a second tactile sensor disposed on a lower surface of the housing, and a third tactile sensor disposed on a side surface of the housing. The processor may be configured to determine that the specified touch is detected, when a touch is sensed by two or more tactile sensors of the first tactile sensor, the second tactile sensor, and the third tactile sensor.

According to an embodiment, the UAV may further include a posture sensor sensing a posture of the UAV. The processor may be configured to increase the output of the at least one motor to perform a hovering operation at the second location, when the detected acceleration value is reduced to the specified value or less and when the posture of the UAV is horizontal with respect to a ground.

According to an embodiment, the posture sensor may include at least one of a geomagnetic sensor or a gyroscope sensor.

According to an embodiment, the processor may be configured to initiate the hovering operation at the second location, after the sensed acceleration value is reduced to the specified value or less and then a specified time elapses.

According to an embodiment, the UAV may further include a camera capturing a video. The processor may be configured to allow the camera to stop the capturing of the video, while the UAV moves from the first location to the second location.

According to an embodiment, the UAV may further include a camera capturing an image of a subject. The processor may be configured to allow the camera to initiate the capturing of the image and to initiate the tracking of the subject, while the UAV moves to the second location.

According to an embodiment, the processor may be configured to allow the camera to apply a specified image processing effect while the UAV moves to the second location.

The term “module” used in this specification may include a unit implemented with hardware, software, or firmware. For example, the term “module” may be interchangeably used with the term “logic”, “logic block”, “component”, “circuit”, and the like. The “module” may be a minimum unit of an integrated part or a part thereof or may be a minimum unit for performing one or more functions or a part thereof. The “module” may be implemented mechanically or electronically and may include, for example, an application-specific IC (ASIC) chip, a field-programmable gate array (FPGA), and a programmable-logic device for performing some operations, which are known or will be developed.

According to various embodiments, at least a part of an apparatus (e.g., modules or functions thereof) or a method (e.g., operations) may be, for example, implemented by instructions stored in a computer-readable storage media in the form of a program module. The instruction, when executed by a processor (e.g., a processor 20), may cause the processor to perform a function corresponding to the instruction. The computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), an embedded memory, and the like. The one or more instructions may contain a code made by a compiler or a code executable by an interpreter.

Each element (e.g., a module or a program module) according to various embodiments may be composed of single entity or a plurality of entities; a part of the above-described sub-elements may be omitted or may further include other elements. Alternatively or additionally, after being integrated in one entity, some elements (e.g., a module or a program module) may identically or similarly perform the function executed by each corresponding element before integration. According to various embodiments, operations executed by modules, program modules, or other elements may be executed by a successive method, a parallel method, a repeated method, or a heuristic method, or at least one part of operations may be executed in different sequences or omitted. Alternatively, other operations may be added.

1. An unmanned aerial vehicle (UAV) comprising:
a housing;
a tactile sensor disposed on at least a partial surface of the housing;
at least one motor;
a propeller connected the at least one motor; and
a processor electrically connected to the tactile sensor and the at least one motor and configured to control the at least one motor,
wherein the tactile sensor includes:
a first tactile sensor disposed on an upper surface of the housing;
a second tactile sensor disposed on a lower surface of the housing; and
a third tactile sensor disposed on a side surface of the housing,
wherein the processor is configured to:
control the at least one motor such that the UAV performs a hovering operation at a first location;
release limitation of vertical movement when a touch is sensed by the first tactile sensor or the second tactile sensor, and release limitation of horizontal movement when a touch is detected by the third tactile sensor;
determine a second location different from the first location, based on the sensed touch; and
control the at least one motor such that the UAV performs a hovering operation at the second location.

2. The UAV of claim 1, wherein the processor is configured to:
when the touch is sensed by the first tactile sensor, determine a location having an altitude lower than an altitude of the first location, as the second location; and
when the touch is sensed by the second tactile sensor, determine a location having an altitude higher than the altitude of the first location, as the second location.

3. The UAV of claim 2, wherein a distance between the first location and the second location is set in advance.

4. The UAV of claim 2, wherein each of the first tactile sensor and the second tactile sensor includes a pressure sensor, and
wherein the processor is configured to:
determine a distance between the first location and the second location, depending on pressure of the touch.

5. The UAV of claim 1, wherein the processor is configured to:
when the touch is sensed by the third tactile sensor, determine a location having an altitude the same as the first location, as the second location, and
wherein a direction from the first location to the second location corresponds to a horizontal component of a direction to which the touch is applied.

6. The UAV of claim 5, wherein a distance between the first location and the second location is set in advance.

7. The UAV of claim 5, wherein the third tactile sensor includes a pressure sensor, and
wherein the processor is configured to:
determine a distance between the first location and the second location, depending on pressure of the touch.

8. The UAV of claim 1, further comprising:
a distance measurement sensor configured to measure a distance to an external object at a periphery of the UAV,
wherein the processor is configured to:
control the at least one motor such that a distance between the second location and the external object is not less than a specified value.

9. The UAV of claim 8, wherein a parameter used by the distance measurement sensor includes one of an ultrasonic wave and an infrared ray.

10. The UAV of claim 1, further comprising:
a camera configured to capture a video for a subject; and
an actuator configured to control a field of view (FoV) of the camera,
wherein the processor is configured to:
while the UAV moves from the first location to the second location, track the subject; and
control the actuator such that the camera captures the video, focusing on the subject.

11. A UAV comprising:
a housing;
a tactile sensor disposed on at least a partial surface of the housing;
an accelerometer disposed inside the housing;
at least one motor;
a propeller connected the at least one motor; and
a processor electrically connected to the tactile sensor and the at least one motor and configured to control the at least one motor,
wherein the processor is configured to:
control the at least one motor such that the UAV performs a hovering operation at a first location;
when a specified touch is sensed by the tactile sensor, release limitation of vertical movement and horizontal movement;
reduce an output of the at least one motor to a specified output value or less; and
when an acceleration value detected by the accelerometer is reduced to a specified value or less, increase the output of the at least one motor to the specified output value or more to perform a hovering operation at a second location, and
wherein the second location corresponds to a location of the UAV at a point in time when an acceleration value is reduced to a specified value or less.

12. The UAV of claim 11, wherein the processor is configured to:
when a touch including contact of a specified area or more is sensed by the tactile sensor, determine that the specified touch is detected.

13. The UAV of claim 11, wherein the processor is configured to:
when a touch including contact during a specified time or longer is sensed by the tactile sensor, determine that the specified touch is detected.

14. The UAV of claim 11, wherein the tactile sensor includes:
a first tactile sensor disposed on an upper surface of the housing;
a second tactile sensor disposed on a lower surface of the housing; and
a third tactile sensor disposed on a side surface of the housing, and
wherein the processor is configured to:
when a touch is sensed by two or more tactile sensors of the first tactile sensor, the second tactile sensor, and the third tactile sensor, determine that the specified touch is detected.

15. The UAV of claim 11, further comprising:
a posture sensor configured to sense a posture of the UAV,
wherein the processor is configured to:
when the detected acceleration value is reduced to the specified value or less and when the posture of the UAV is horizontal with respect to a ground, increase the output of the at least one motor to perform a hovering operation at the second location.
